(19) United States
(12) Patent Application Publication
(10) Pub. No.: US 2025/0024474 A1
(43) Pub. Date: Jan. 16, 2025

(54) SIMULTANEOUS NR SIDELINK COMMUNICATION AND SIDELINK POSITIONING

(71) Applicant: Nokia Technologies Oy, Espoo (FI)

(72) Inventors: Berthold PANZNER, Munich (DE); Stepan KUCERA, Munich (DE); Taylan SAHIN, Munich (DE); Prajwal KESHAVAMURTHY, Munich (DE)

(21) Appl. No.: 18/708,841

(22) PCT Filed: Nov. 24, 2022
(86) PCT No.: PCT/EP2022/083069

§ 371 Date: May 9, 2024

Related U.S. Application Data
(60) Provisional application No. 63/292,006, filed on Dec. 21, 2021.

(51) Int. Cl. H04W 72/40; H04L 5/00; H04W 72/0453

(52) U.S. Cl. CPC H04W 72/40; H04L 5/0051; H04W 72/0453

(57) ABSTRACT

Disclosed in a mechanism for determining, by a third user equipment, information identifying at least one selected sidelink resource for use in sidelink operations with a fourth user equipment in a sidelink communication network; identifying a resource conflict of the at least one selected sidelink resource with at least one sidelink data transmission from a first user equipment to a second user equipment of the sidelink communication network, and based on the determining, providing signalling to at least one of the first user equipment or the fourth user equipment to avoid the resource conflict.

### TECHNICAL FIELD

The teachings in accordance with the exemplary embodiments of this invention relate generally to new radio sidelink communication and sidelink positioning, and more specifically, relate to new radio Sidelink communication and sidelink positioning to avoid resource conflicts/collisions caused by simultaneous sidelink communication and (wideband) sidelink positioning transmission(s).

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:

| | |
|---|---|
| FDM | frequency division multiplex |
| MAC PDU | medium access control protocol data unit |
| NR | new radio |
| PRB | physical resource block |
| PRS | positioning reference signal |
| PSFCH | physical sidelink feedback channel |
| PSSCH | physical sidelink shared channel |
| SC | sub-carrier |
| SCI | sidelink control information |
| SL | sidelink |
| SL-BWP | sidelink bandwidth part |
| SL-PRS | sidelink positioning reference signal/sequence |
| Tx | transmission |
| UE | user equipment |

Sidelink (SL) communication is a communication scheme in which a direct link is established between different User Equipment (UEs). In Sidelink communication UEs and network device exchange voice and data directly with each other.

With the incredible growth in the number of connected devices and the increase in user/network traffic volume, various efforts have been made to improve different aspects of wireless communication including sidelink communication. These improvements for the next-generation wireless communication system, such as the fifth-generation (5G) New Radio (NR), by improving data rate, latency, reliability, and mobility.

Accordingly, there is a need to improve the efficiency of sidelink wireless communications. Example embodiments of the invention as disclosed herein provide such improvements.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

According to an example embodiment of the present invention, a method is provided, comprising: determining, by a third user equipment, information identifying at least one selected sidelink resource for use in sidelink operations with a fourth user equipment in a sidelink communication network; identifying a resource conflict of the at least one selected sidelink resource with at least one sidelink data transmission from a first user equipment to a second user equipment of the sidelink communication network; and based on the determining, providing signalling to at least one of the first user equipment or the fourth user equipment to avoid the resource conflict.

In further refinements of the above example method embodiment, the information comprises a sidelink positioning reference signal configuration and reservation. The signalling comprises one of a skip pre-emption indication or signalling to the first user equipment or a frequency offset indication to the fourth user equipment. The skip pre-emption indication or signalling causes the first user equipment to refrain from applying pre-emption or reselection of sidelink resources regardless of whether pre-emption is disabled or enabled in a resource pool at the first user equipment. The skip pre-emption indication or signalling is multiplexed with at least one of physical sidelink shared channel or physical sidelink feedback channel resources associated with an existing physical sidelink shared channel of the first user equipment. The skip pre-emption indication or signalling is multiplexed in a frequency domain or a code domain using a specific cyclic shift of the physical sidelink feedback channel resources. The frequency offset indication is signalled in a sidelink control information associated with the sidelink positioning reference signal. The frequency offset indication is indicating an offset of the more than one selected sidelink resource in order for the at least one sidelink data transmission and the more than one selected sidelink resource to occur on non-overlapping sidelink resources. The frequency offset indication comprises at least one of: a number of offsetted subcarriers, a number of offsetted resource blocks, or a number of offsetted subchannels. The number of offsetted subcarriers is used in case the at least one selected sidelink resource granularity is at least one sub-carrier, the number of offsetted resource blocks is used in case the at least one selected sidelink resource granularity is at least one physical resource block, and the number of offsetted subchannels is used in case the at least one selected sidelink resource granularity is at least one sub-channel. The information comprises one of a down shift direction to a lower frequency or an up shift direction to a higher frequency of the frequency offset indication. The frequency offset indication corresponds to a pre-defined value. The information identifying the at least one selected sidelink resource is for localizing the third user equipment.

According to a further example embodiment of the present invention, an apparatus is provided, the apparatus comprising at least one processor; and at least one non-transitory memory including computer program code, where the at least one non-transitory memory and the computer program code are configured, with the at least one processor, to cause the apparatus to at least: determine, by a third user equipment, information identifying at least one selected sidelink resource for use in sidelink operations with a fourth user equipment in a sidelink communication network; identify a resource conflict of the at least one selected sidelink resource with at least one sidelink data transmission from a first user equipment to a second user equipment of the sidelink communication network; and based on the determining, provide signalling to at least one of the first user equipment or the fourth user equipment to avoid the resource conflict.

In further refinements of the above example apparatus embodiment, the information comprises a sidelink positioning reference signal configuration and reservation. The signalling comprises one of a skip pre-emption indication or signalling to the first user equipment or a frequency offset indication to the fourth user equipment. The skip pre-emption indication or signalling causes the first user equipment to refrain from applying pre-emption or reselection of sidelink resources regardless of whether pre-emption is disabled or enabled in a resource pool at the first user equipment. The skip pre-emption indication or signalling is multiplexed with at least one of physical sidelink shared channel or physical sidelink feedback channel resources associated with an existing physical sidelink shared channel of the first user equipment. The skip pre-emption indication or signalling is multiplexed in a frequency domain or a code domain using a specific cyclic shift of the physical sidelink feedback channel resources. The frequency offset indication is signalled in a sidelink positioning reference signal frequency offset sequence. The frequency offset indication is indicating an offset of the more than one selected sidelink resource in order for the at least one sidelink data transmission and the more than one selected sidelink resource to occur on non-overlapping sidelink resources. The frequency offset indication comprises at least one of: a number of offsetted subcarriers, a number of offsetted resource blocks, or a number of offsetted subchannels. The number of offsetted subcarriers is used in case the at least one selected sidelink resource granularity is at least one sub-carrier, the number of offsetted resource blocks is used in case the at least one selected sidelink resource granularity is at least one physical resource block, and the number of offsetted subchannels is used in case the at least one selected sidelink resource granularity is at least one sub-channel. The information comprises one of a down shift direction to a lower frequency or an up shift direction to a higher frequency of the frequency offset indication. The frequency offset indication corresponds to a pre-defined value. The information identifying the at least one selected sidelink resource is for localizing the third user equipment.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a scenario of sidelink UEs with SL communication and SL positioning;

FIG. 2 shows 2(a) sidelink resource reservation and 2(b) expected SL-PRS;

FIG. 3 shows a conflict by overlapping SL-communication and SL-PRS;

FIG. 4 shows one solution in accordance with example embodiments of the invention; and

FIG. 5 shows a flowchart of operations in accordance with example embodiments of the invention;

FIG. 6 shows a high level block diagram of various devices used in carrying out various aspects of the invention; and

FIG. 7 shows a method in accordance with example embodiments of the invention which may be performed by an apparatus.

### DETAILED DESCRIPTION

In this invention, there is proposed novel operations to improve new radio sidelink communication and sidelink positioning such as to avoid resource conflicts/collisions caused by simultaneous sidelink communication and (wideband) sidelink positioning transmission(s).

Example embodiments of the invention relate to NR sidelink communication. Features of the example embodiments of this invention include resource allocation for NR SL communication in particular resource pre-emption. Example embodiments of the invention work to change and improve the behavior in resource allocation for NR SL communication, and in particular provided improved operations for resource pre-emption as disclosed in 3GPP TS38.321 section 5.22.1.2a.

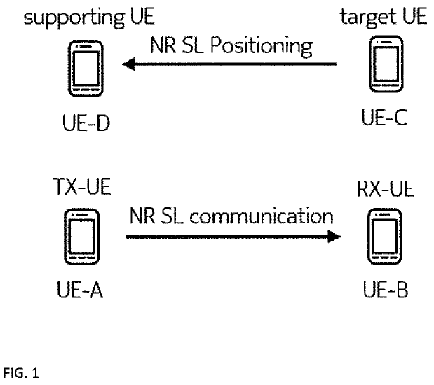

Example embodiments of the invention address a problem that NR sidelink communication and transmission of SL-PRS for sidelink positioning must co-exist, as will be specified in upcoming standards at the time of this application. To illustrate the conflict that arises from simultaneous transmissions of SL data and SL-PRS let us consider the scenario in FIG. 1. As shown in FIG. 1 a pair of sidelink UEs (UE A and UE B) may communicate with each other over PC5 (i.e., payload data exchange over sidelink) while a set of other UEs (UE C and UE D) may engage in sidelink positioning. As shown in FIG. 1 the link between UE A and UE B represents sidelink communication and the link between UE D and UE C represents sidelink positioning.

According to NR sidelink specification a sidelink TX-UE (UE A) may indicate/reserve up to three future sidelink resource allocation in its SCI. The selection of the sidelink resources of UE A might be up to gNB (in RA mode 1) or by the UE itself (in RA mode 2) based on the knowledge of existing or announced sidelink interference (e.g. by reported preferred/non-preferred sidelink resources by UE B).

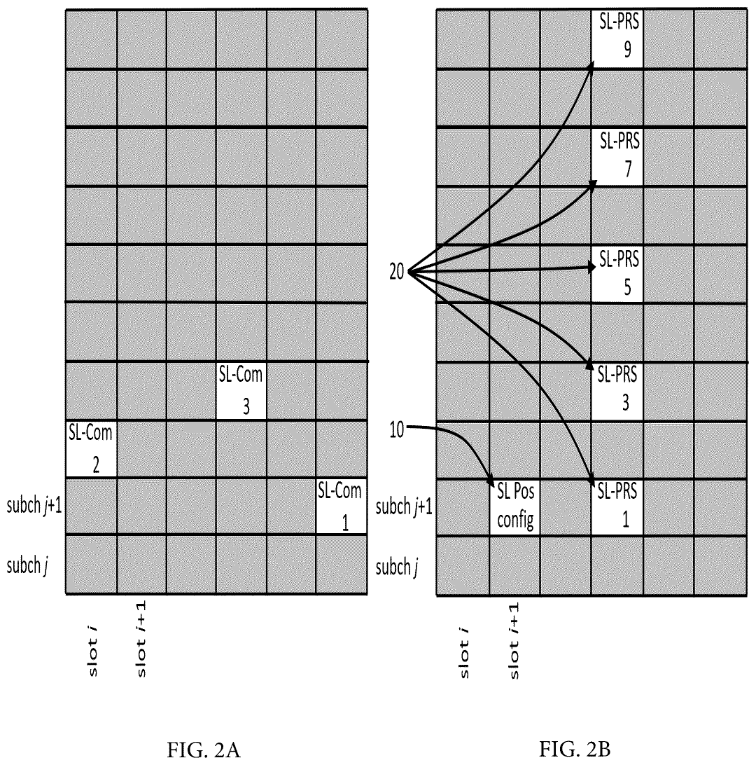

FIG. 2a shows one example of 3 selected sidelink resource allocations labelled 1, 2, and 3 that are announced by UE A's SCI in its first transmission (slot i, subchannel j+2). Here we assume that the resource pool for UE A's transmission to UE B has set sidelink pre-emption enabled.

Although the exact signal definition (or sequence) of the SL-PRS is not known at the moment (need to specified by RAN1 in the context of Rel-18 SL_Pos) we can assume that the SL-PRS will be:
wideband sequence/signal (to utilize the relation between bandwidth and positioning accuracy),
comb-like signal/sequence, and
most likely similar to existing PRS for Uu.

Hence we assume that SL-PRS will occupy the largest available frequency domain resources (either a full SL-BWP or the maximum number of subchannels in a configured sidelink resource pool) to maximize the achievable accuracy (the higher the bandwidth of a SL-PRS the higher the positioning accuracy) such as PRB's 1, 3, 5, 7, and 9 as shown in FIG. 2(B).

So when the sidelink target UE (UE C) either reserves or performs a SL-PRS transmission that may result in:
blocking the whole logical sidelink slot possibly creating resource conflict(s) in highly congested sidelink scenarios, and/or
creating sidelink resource fragmentation resulting in lower sidelink spectral efficiency

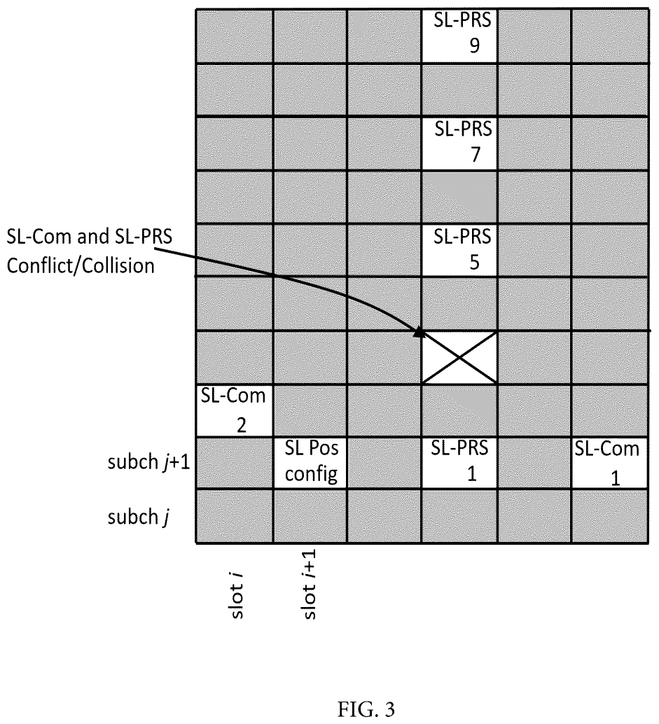

If a sidelink target UE (UE C) reserves/allocates (shown as SL-All 10) different SL-PRS (shown as SL-PRS 20) as in FIG. 2b (because target UE (UE C) could either not find a better slot or the gNB of the target UE has scheduled slot i+3 for the SL-PRS transmission) then that results in a sidelink resource conflict for the 2^{nd} transmission of UE A. So there is a resource collision/conflict in slot i+3 and subchannel j+3 as shown in FIG. 3.

As per NR SL specification the UE A would (once it is becoming aware about the resource conflict) perform pre-emption (i.e. backing-off from already reserved sidelink resources and refraining from the second transmission) and do a resource reselection (choosing a different sidelink resource). For details on pre-emption it can be referred to TS38.321 section 5.22.1.2a. In a nutshell:
A sidelink UE triggers reselection of already signaled resource(s) as a resource reservation in case of overlap with resource(s) of a higher priority reservation from a different UE and, SL-RSRP measurement associated with the resource reserved by that different UE is larger than an associated SL-RSRP threshold:
   Only the overlapped resource(s) is/are reselected;
The application of pre-emption can apply between all priorities of data traffic (sl-PreemptionEnable is present and the value is enabled), or only when the priority of the pre-empting traffic is higher than a threshold and higher than that of the pre-empted traffic (sl-PreemptionEnable is present and the value is pl1,pl2, . . . );
A sidelink UE does not need to consider the possibility of pre-emption later than time T3 before the particular slot containing the reserved resources; and/or
This mechanism can be enabled or disabled, per resource pool

Hence the simultaneous sidelink communication and SL positioning may result in pre-emption for the SL data traffic, further resulting in resource conflicts and/or fragmentation of sidelink resources.

This invention comprises an apparatus and method to avoid resource conflicts/collisions caused by simultaneous sidelink communication and (wideband) sidelink positioning transmission(s).

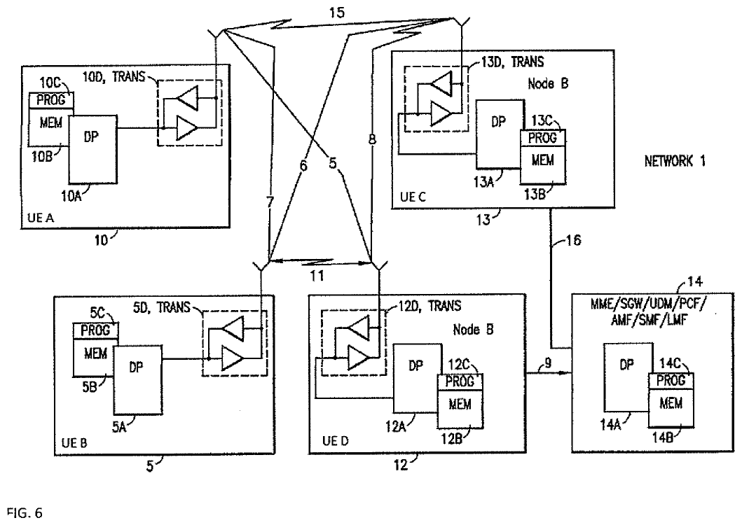

Before describing the example embodiments of the present disclosure in detail, reference is made to FIG. 6 for illustrating a simplified block diagram of various electronic devices of one possible and non-limiting exemplary system that are suitable for use in practicing the example embodiments of the present disclosure.

FIG. 6 shows a block diagram of one possible and non-limiting exemplary system in which the example embodiments of the present disclosure may be practiced. In FIG. 6, a user equipment UE A, a user equipment UE B, a user equipment UE C, and a user equipment UE D is in wireless communication with a wireless network 1 or network 1 as in FIG. 6. It is noted that UE A, UE B, UE C, and UE D can be representative of a first user equipment, a second user equipment, a third user equipment, and a fourth user equipment, respectively, as disclosed herein

The wireless network 1 or network 1 as in FIG. 6 can comprise a communication network such as a mobile network e.g., the mobile network 1 or first mobile network as disclosed herein. Any reference herein to a wireless network 1 as in FIG. 6 can be seen as a reference to any wireless network as disclosed herein. Further, the wireless network 1 as in FIG. 6 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded, vehicle-mounted mobile device, or arial device and performs a language signaling and/or data exchange with the RAN.

The UE A (user equipment A) includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to UE B, UE C, and/or UE D, respectively. The one or more memories MEM 10B include computer program code PROG 10C. The UE A communicates with UE B, UE C, and/or UE D via a wireless link 5, 7, or 15, respectively. The one or more memories MEM 10B and the computer program code PROG 10C are configured to cause, with the one or more processors DP 10A, the UE A to perform one or more of the operations as described herein.

The UE B (user equipment B) includes one or more processors DP 5A, one or more memories MEM 5B, and one or more transceivers TRANS 5D interconnected through one or more buses. Each of the one or more transceivers TRANS 5D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 5D which can be optionally connected to one or more antennas for communication to UE A, UE C, and/or UE D, respectively. The one or more memories MEM 5B include computer program code PROG 5C. The UE B communicates with UE A, UE C, and/or UE D via a wireless link 7, 6, or 11, respectively. The one or more memories MEM 5B and the computer program code PROG 5C are configured to cause, with the one or more processors DP 5A, the UE B to perform one or more of the operations as described herein.

The UE C (user equipment C) is a network node that communicates with devices such as UE D, UE B, and/or UE A of FIG. 6. The UE C can be associated with a mobility function device such as an AMF or SMF, further the UE C may comprise a NR/5G Node B or possibly an evolved NB, a base station such as a master or secondary node base station (e.g., for NR or LTE) that communicates with devices such as the UE D and/or UE B and/or UE A in the wireless network 1. The UE C includes one or more processors DP 13A, one or more memories MEM 13B, one or more network interfaces, and one or more transceivers TRANS 12D interconnected through one or more buses. In accordance with the example embodiments these network interfaces of UE C can include X2 and/or Xn interfaces and/or other interfaces for use to perform the example embodiments of the present disclosure. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the UE C to perform one or more of the operations as described herein. The UE C may communicate with the UE A, UE B, and/or UE D or any other device using, e.g., at least link 15 and/or link 6. The link, 15, 8, or 6 as shown in FIG. 6 can be used for communication between the UE C and UE A, UE B, and/or UE D. It is noted that any of the link as disclosed herein can comprise one or more sidelink links. In addition, any of these links.

The UE D (user equipment D) is a network node that communicates with devices such as UE C, UE B, and/or UE A of FIG. 6. The UE D provides access to wireless devices such as the UE A, UE B, and/or UE C to the wireless network 1. The UE D includes one or more processors DP 12A, one or more memories MEM 12B, and one or more transceivers TRANS 12D interconnected through one or more buses. In accordance with the example embodiments these TRANS 12D can include X2 and/or Xn and/or other interfaces for use to perform the example embodiments of the present disclosure. Each of the one or more transceivers TRANS 12D includes a receiver and a transmitter. The one or more transceivers TRANS 12D can be optionally connected to one or more antennas for communication over at least link 11 and/or link 5 and/or link 8. The TRANS 12D can connect with the UE B and/or UE A via links 11 or link 5, respectively. The one or more memories MEM 12B and the computer program code PROG 12C are configured to cause, with the one or more processors DP 12A, the UE D to perform one or more of the operations as described herein. The UE D may communicate with another gNB or eNB, or a device such as the UE A, UE B, and/or UE C such as via link 8, 11, and/or 5. Further any of the links as disclosed herein may be wired or wireless or both. Further any of the links as disclosed herein may be configured to be through other network devices such as, but not limited to an SGW/AMF/UPF device such as the MME/SGW/UDM/PCF/AMF/SMF/LMF 14 of FIG. 6. The UE D may perform functionalities of a Mobility Management Entity (MME), Serving Gateway (SGW), Unified Data Management (UDM), Policy Control Function (PCF), User Plane Function (UPF), Access and Mobility Management Function (AMF) and/or a Location Management function (LMF) for LTE and similar functionality for 5G.

It is noted that that the UE A, UE B, UE C, and/or UE D can be configured (e.g. based on standards implementations etc.) to perform functionality of a Location Management Function (LMF). The LMF functionality may be embodied in either of the UE A, UE B, UE C, and/or UE D or may be part of these network devices or other devices associated with these devices. In addition, an LMF such as the LMF of the MME/SGW/UDM/PCF/AMF/SMF/LMF 14 of FIG. 6, as at least described below, can be co-located with the UE A, UE B, UE C, and/or UE D such as to be separate from the UE D and/or UE C of FIG. 6 for performing operations in accordance with example embodiments of the invention as disclosed herein.

These links, for instances, links 5, 6, 7, 8, 11, 15, 16, and 9 maybe wired or wireless or both and the links and/or other interfaces such as being shown in FIG. 6 or FIG. 6 may implement Xn/X2 e.g., link 8 between the UE A, UE B, UE C, and/or UE D can include an X2/Xn interface type link. Further, as stated above any of these links may be through other network devices such as, but not limited to an MME/SGW device such as the MME/SGW/UDM/PCF/AMF/SMF/LMF 14 of FIG. 6. The MME/SGW/UDM/PCF/AMF/SMF/LMF 14 of FIG. 6 may be used to control any functions of any of the devices of the Network 1 as shown in FIG. 6.

The one or more buses of the device of FIG. 6 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D, TRANS 5D, and/or TRANS 10D may be implemented as a remote radio head (RRH), with the other elements of the UE A, UE B, UE C, and/or UE D being physically in a different location from the RRH, and one or more buses could be implemented in part as fiber optic cable to connect the other elements of the UE A, UE B, UE C, and/or UE D to a RRH for example.

It is noted that although FIG. 6 shows a network nodes Such as UE A, UE B, UE C, and/or UE D. Any of these nodes can communicate with an eNodeB or eNB or gNB such as for LTE and NR, and would still be configurable to perform example embodiments of the present disclosure.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a MME/SGW/UDM/PCF/AMF/SMF/LMF 14 that may include Mobility Management Entity (MME), and/or Serving Gateway (SGW), and/or Unified Data Management (UDM), and/or Policy Control Function (PCF), and/or Access and Mobility Management Function (AMF), and/or Session Management Function (SMF), and/or Authentication Server Function (AUSF) and/or Location Management Function (LMF) and which provides connectivity with a further network, such as a telephone network and/or a data communications network (e.g., the Internet), and which is configured to perform any 5G and/or NR operations in addition to or instead of other standards operations at the time of this application. The MME/SGW/UDM/PCF/AMF/SMF/LMF 14 is configurable to perform operations in accordance with example embodiments of the present disclosure in any of an LTE, NR, 5G and/or any standards based communication technologies being performed or discussed at the time of this application. In addition, it is noted that the operations in accordance with example embodiments of the present disclosure, as performed by the UE D and/or UE C, may also be performed at the MME/SGW/UDM/PCF/AMF/SMF/LMF 14.

Regarding the LMF functionality of the MME/SGW/UDM/PCF/AMF/SMF/LMF 14 of FIG. 6, the LMF receives measurements and assistance information from the communication network and user equipment (UE). This can be via an Access and Mobility Management Function (AMF) over an interface to determine a position of the UE. The UE B and/or the UE A as in FIG. 6 may communicate with the LMF via at least any of links 5, 6, 11, and/or 15. The UE D and/or NN13 can if necessary then further communicate with the LMF of the MME/SGW/UDM/PCF/AMF/SMF/LMF 14 of FIG. 6 via the link 16 or link 9 as in FIG. 6.

It is noted that the link 16 or link 9 can include any links needed between UE B, UE A, UE D, and/or UE C and the MME/SGW/UDM/PCF/AMF/SMF/LMF 14 of FIG. 6 for any of these devices to communicate with at least the LMF of the MME/SGW/UDM/PCF/AMF/SMF/LMF 14 of FIG. 6. Further, it is noted that any of links that are mentioned in this paper can include hardwired links and/or wireless links and, as needed, and/or include any type of interface (e.g., LTE and/or 5G interface) such as but not limited to at least one of an Xn, X2, S1, NG, NG-C, NLs, E1, and/or F1 type interface.

The MME/SGW/UDM/PCF/AMF/SMF/LMF 14 includes one or more processors DP 14A, one or more memories MEM 14B, and one or more network interfaces (N/W I/F(s)), interconnected through one or more buses coupled with at least links 16 and 9. Communication between the UE D or UE C and the LMF may be performed via an Access and Mobility Management function (AMF) e.g., of the MME/SGW/UDM/PCF/AMF/SMF/LMF 14. A control plane interface between UE D and/or UE C (or a gNB) and AMF can be an NG-C interface and an interface between the AMF and LMF can be NLs. In accordance with the example embodiments these network interfaces can include X2 and/or Xn and/or other interfaces for use to perform the example embodiments of the present disclosure. The one or more memories MEM 14B include computer program code PROG 14C. The one or more memories MEM14B and the computer program code PROG 14C are configured to, with the one or more processors DP 14A, cause the MME/SGW/UDM/PCF/AMF/SMF/LMF 14 to perform or work with the UE D or UE C to perform one or more operations which may be needed to support the operations in accordance with the example embodiments of the present disclosure.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, DP5A, and/or DP14A and memories MEM 10B, MEM 12B, MEM 13B, MEM 5B, and/or MEM 14B, and also such virtualized entities create technical effects.

The computer readable memories MEM 12B, MEM 13B, MEM 5B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, MEM 5B, and MEM 14B may be means for performing storage functions. The processors DP10, DP12A, DP13A, DP5A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, DP5A, and DP14A may be means for performing functions, such as controlling the UE A, UE B, UE D, UE C, and other functions as described herein.

In general, various embodiments of the UE B and/or UE A can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of UE B or UE A can be used with a UE vehicle, a High Altitude Platform Station, or any other such type node associated with a terrestrial network or any drone type radio or a radio in aircraft or other airborne vehicle. The UE B or UE A can be an anchor UE or a target UE in accordance with example embodiments of the invention.

As similarly stated above, example embodiments of this invention relate to avoidance of resource conflicts/collisions caused by simultaneous sidelink communication and (wideband) sidelink positioning transmission(s).

In one embodiment the target UE (UE C) (i.e. the UE to be localized, UE transmitting SL-PRS) provides a novel skip pre-emption indication to the TX-UE (UE A) in case of conflicting sidelink resource allocation.

The skip pre-emption indication is sent by the target UE (UE C) on modified PSFCH resource(s) associated with UE A's PSSCH (i.e. UE C is transmitting skip pre-emption on PSFCH resources belonging to UE A).

Essentially a UE not involved in the sidelink communication (between a set of sidelink UEs (UE A and UE B) however involved in sidelink positioning provides the skip_pre-emption indication to at least one TX-UE having reserved a sidelink transmission opportunity with a resource conflict.

The skip_pre-emption indication sent by UE C informs UE A to refrain from applying pre-emption/reselection regardless of the value of sl-PreemptionEnable i.e. even if sl-PreemptionEnable is set to enable or pl1,pl2, . . . ,pl8 for the selected sidelink grant for a MAC PDU, pre-emption is not applied. The TX-UE (UE A) continues its planed sidelink transmission as previously indicated in the prior SCI.

Thus the skip-pre-emption indication allows a TX-UE (UE A) to deviate from the current resource reselection behavior (as referred to in MAC section of 3GPP TS38.321 section 5.22.1.2) in order to allow for simultaneous SL communication and SL-PRS transmission.

Depending on the pattern/structure of the SL-PRS the target UE (UE C) may offset the SL-PRS comb in order to avoid a resource collision/overlap with UE A's transmission.

The target UE (UE C) indicates the frequency offset of the announced SL-PRS sequence to its supporting UEs (UE D) in a novel SL-PRS-freq-offset indication.

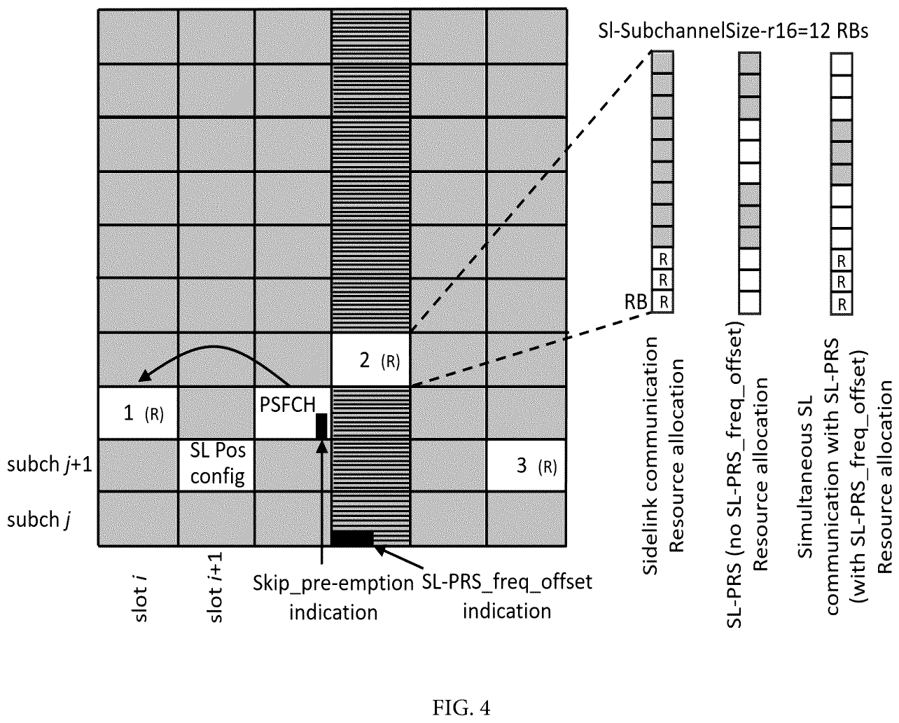

We use the illustration in FIG. 4 below to illustrate the implementation details. The parallel resource allocation for NR sidelink communication and sidelink positioning may create resource conflicts such as the one in slot i+3, subchannel j+3. In FIG. 4 we assume exemplarily that the sidelink transmission #2 occupies the first 3 PRBs of the subchannel (Note: as of NR sidelink Rel-16 and Rel-17 only contiguous PRBS can be scheduled). Furthermore we assume in the illustration that the SL-PRS is comb-like sequence with a frequency pattern of 3 PRBs.

Without the solution in this application the TX-UE (UE A) is forced to pre-empt its sidelink transmission potentially further creating additional conflicts caused by the resource reselection. In case the target UE (UE C) is aware about this conflict (by monitoring UE A's SCI in the first SL transmission slot i+0, subchannel j+2) the novel skip_pre-emption indication is sent from the target UE (UE C) that itself is not involved in NR SL communication (but involved in SL positioning) to the sidelink communication TX-UE (UE A). The skip_pre-emption indication can be multiplexed with the PSFCH resources associated with UE A's PSSCH transmission (in FIG. 4 slot i+2) effectively informing UE A that it should refrain from (sidelink) pre-emption and keep its originally scheduled sidelink transmission unchanged (note: deviating from the current standards behavior). The multiplexing of the skip_pre-emption with the existing PSFCH resources can be in frequency domain (i.e. skip_pre-emption is FDMed with PSFCH resources) or in code domain (i.e. skip_pre-emption indication may use a specific cyclic shift of the PSFCH sequence).

In another embodiment the supporting UE(s) (UE D reporting the monitored SL-PRS to UE C) may send the skip_pre-emption indication on behalf of the target UE (UE C).

In order to avoid resource collision the target UE (UE C) may offset its SL-PRS in frequency domain such that SL communication and SL positioning occur on non-overlapping/orthogonal sidelink resources. The target UE (UE C) forced to offset its SL-PRS by certain amount of frequency resources is indicating this in the SL-PRS_freq_offset indication.

In the example in FIG. 4 the SL-PRS is a comb that occupies periodically 3 PRBs. The sidelink communication transmission occupies the lower 3PRBs of the subchannel (here 1 subchannel is configured to have 12 PRBs).

By shifting (frequency offsetting) the SL-PRS comb up by 3 PRBs, the orthogonality in frequency domain is achieved.

The SL-PRS-freq-offset can be signalled in the SL-PRS control information (i.e. the SCI associated with the SL-PRS). In case the SL-PRS uses the standardized SCI format for allocating resources for the SL-PRS transmission the SL-PRS_freq_offset can be integrated into the SCI by using an additional IE.

With the reception of the SL-PRS_freq_offset the supporting UEs UE D (monitoring the SL-PRS) are informed about the changed/frequency shifted SL-PRS allocation.

The value of the SL-PRS_freq_offset may contain (but not limited to) the:
embodiment 1: number of offsetted subcarriers (in case the SL-PRS comb granularity is a SC or multiple SCs),
embodiment 2: number of offsetted resource blocks (in case the SL-PRS comb granularity is a PRB or multiple PRBs), and/or
embodiment 3: number of offsetted subchannels (in case the SL-PRS comb granularity is a SubCh or multiple SubChs)

In another embodiment the direction of the offset (i.e. whether to shift up or down) may be indicated in addition to the absolute value of shifted frequency resources.

In another embodiment the SL-PRS_freq_offset may correspond to a fixed pre-defined value (frequency offset depending on the SL-PRS comb structure). In this case the SL-PRS_freq_offset can be represented by a Boolean value i.e. SL-PRS_freq_offset=enabled means for example SL-PRS is shifted up by 3 PRBs.

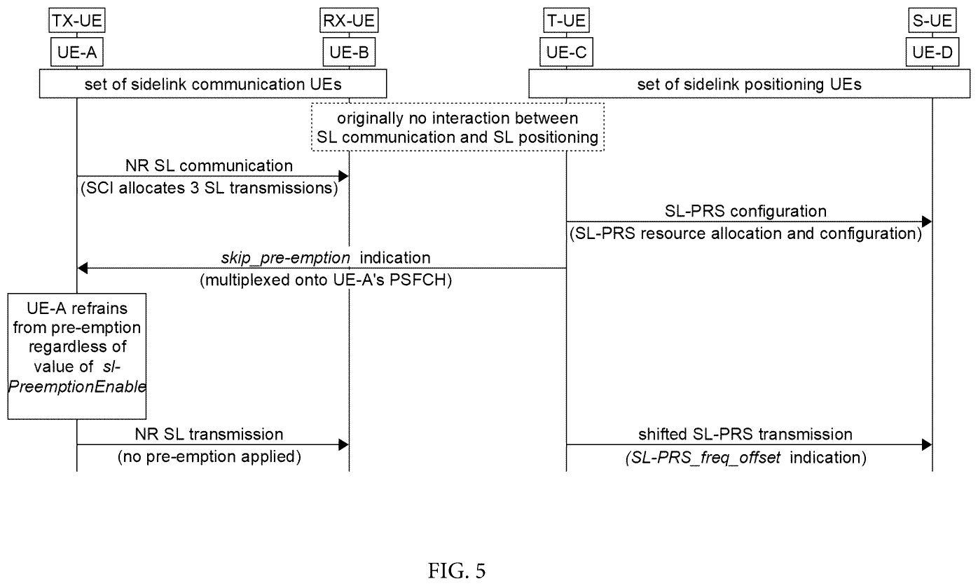

FIG. 5 shows a flowchart of operations in accordance with example embodiments of the invention. FIG. 5 shows NR SL communication operations between a UE A and a UE B, and shows SL-PRS resource allocation operations between a UE C and a UE D. As shown in step 510 of FIG. 5 the NR SL communication operations are in a set of sidelink communication UEs, and the SL-PRS resource allocation operations are between a set of sidelink positioning UEs. As shown in step 515 of FIG. 5 there is originally no interaction between the set of sidelink communication UEs and the set of sidelink positioning UEs.

It is noted that in accordance with example embodiments of the invention as disclosed herein in standards or standards submissions at the time of this application the following change needs to be applied:
1> if a resource(s) of the selected sidelink grant has received a skip-pre-emption indication associated with the Sidelink process,
2> keep transmitting on the select the time and frequency resource from the resources indicated by the physical layer as specified the standards regardless of the value in sl-PreemptionEnable as discussed above.

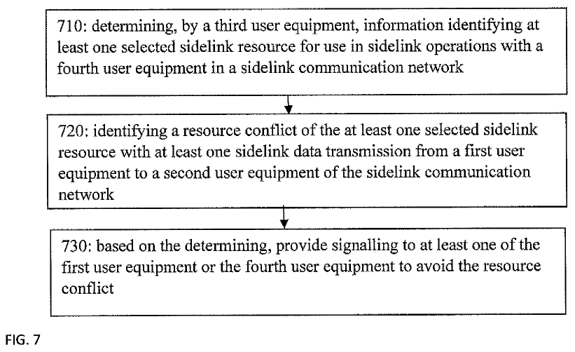

FIG. 7 shows a method in accordance with example embodiments of the invention which may be performed by an apparatus.

FIG. 7 illustrates operations which may be performed by devices such as, but not limited to devices (e.g., the UE A, UE B, UE C, and/or UE D as in FIG. 6).

As shown in step 710 of FIG. 7 there is determining, by a third user equipment, information identifying at least one selected sidelink resource for use in sidelink operations with a fourth user equipment in a sidelink communication network. As shown in step 720 of FIG. 7 there is identifying a resource conflict of the at least one selected sidelink resource with at least one sidelink data transmission from a first user equipment to a second user equipment of the sidelink communication network. Then as shown in step 730 of FIG. 7 there is, based on the determining, providing signalling to at least one of the first user equipment or the fourth user equipment to avoid the resource conflict.

In accordance with the example embodiments as described in the paragraph above, wherein the information comprises a sidelink positioning reference signal configuration and reservation.

In accordance with the example embodiments as described in the paragraphs above, wherein the signalling comprises one of a skip pre-emption indication or signalling to the first user equipment or a frequency offset indication to the fourth user equipment.

In accordance with the example embodiments as described in the paragraphs above, wherein the skip pre-emption indication or signalling causes the first user equipment to refrain from applying pre-emption or reselection of sidelink resources regardless of whether pre-emption is disabled or enabled in a resource pool at the first user equipment.

In accordance with the example embodiments as described in the paragraphs above, wherein the skip pre-emption indication or signalling is multiplexed with at least one of physical sidelink shared channel or physical sidelink feedback channel resources associated with an existing physical sidelink shared channel of the first user equipment.

In accordance with the example embodiments as described in the paragraphs above, wherein the skip pre-emption indication or signalling is multiplexed in a frequency domain or a code domain using a specific cyclic shift of the physical sidelink feedback channel resources.

In accordance with the example embodiments as described in the paragraphs above, wherein the frequency offset indication is signalled in a sidelink positioning reference signal frequency offset sequence.

In accordance with the example embodiments as described in the paragraphs above, wherein the frequency offset indication is indicating an offset of the more than one selected sidelink resource in order for the at least one sidelink data transmission and the more than one selected sidelink resource to occur on non-overlapping sidelink resources.

In accordance with the example embodiments as described in the paragraphs above, wherein the frequency offset indication comprises at least one of: a number of offsetted subcarriers, a number of offsetted resource blocks, or a number of offsetted subchannels.

In accordance with the example embodiments as described in the paragraphs above, wherein the number of offsetted subcarriers is used in case the at least one selected sidelink resource granularity is at least one sub-carrier, wherein the number of offsetted resource blocks is used in case the at least one selected sidelink resource granularity is at least one physical resource block, and wherein the number of offsetted subchannels is used in case the at least one selected sidelink resource granularity is at least one sub-channel.

In accordance with the example embodiments as described in the paragraphs above, wherein the information comprises one of a down shift direction to a lower frequency or an up shift direction to a higher frequency of the frequency offset indication.

In accordance with the example embodiments as described in the paragraphs above, wherein the frequency offset indication corresponds to a pre-defined value, such as a pre-defined value defined by a network.

In accordance with the example embodiments as described in the paragraphs above, wherein the information identifying the at least one selected sidelink resource is for localizing the third user equipment.

A non-transitory computer-readable medium (MEM 10B, MEM 5B, MEM 13B, and/or MEM 12B as in FIG. 6) storing program code (PROG 10C, PROG 5C, PROG 13C, and/or PROG 12C as in FIG. 6), the program code executed by at least one processor (DP 10A, DP 5A, DP 13A, and/or DP 12A as in FIG. 6) to perform the operations as at least described in the paragraphs above.

In accordance with an example embodiment of the invention as described above there is an apparatus comprising: means for determining (TRANS 10D, TRANS 5D, TRANS 13D, and/or TRANS 12D, MEM 10B, MEM 5B, MEM 13B, and/or MEM 12B, PROG 10C, PROG 5C, PROG 13C, and/or PROG 12C, and DP 10A, DP 5A, DP 13A, and/or DP 12A as in FIG. 6), by a third user equipment (UE C as in FIG. 6), information identifying at least one selected sidelink resource for use in sidelink operations with a fourth user equipment in a sidelink communication network; means for identifying (TRANS 10D, TRANS 5D, TRANS 13D, and/or TRANS 12D, MEM 10B, MEM 5B, MEM 13B, and/or MEM 12B, PROG 10C, PROG 5C, PROG 13C, and/or PROG 12C, and DP 10A, DP 5A, DP 13A, and/or DP 12A as in FIG. 6) a resource conflict of the at least one selected sidelink resource with at least one sidelink data transmission from a first user equipment (UE A as in FIG. 6) to a second user equipment (UE B as in FIG. 6) of the sidelink communication network (Network 1 as in FIG. 6); then means, based on the determining, for providing (TRANS 10D, TRANS 5D, TRANS 13D, and/or TRANS 12D, MEM 10B, MEM 5B, MEM 13B, and/or MEM 12B, PROG 10C, PROG 5C, PROG 13C, and/or PROG 12C, and DP 10A, DP 5A, DP 13A, and/or DP 12A as in FIG. 6) signalling to at least one of the first user equipment (UE A as in FIG. 6) or the fourth user equipment (UE D as in FIG. 6) to avoid the resource conflict.

In the example aspect of the invention according to the paragraph above, wherein at least the means for determining, identifying, and providing comprises a non-transitory computer readable medium [MEM 10B, MEM 5B, MEM 13B, and/or MEM 12B as in FIG. 6] encoded with a computer program [PROG 10C, PROG 5C, PROG 13C, and/or PROG 12C as in FIG. 6] executable by at least one processor [DP 10A, DP 5A, DP 13A, and/or DP 12A as in FIG. 6].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-26. (canceled)

27. A method, comprising:
determining, by a third user equipment, information identifying at least one selected sidelink resource for use in sidelink operations with a fourth user equipment in a sidelink communication network;
identifying a resource conflict of the at least one selected sidelink resource with at least one sidelink data transmission from a first user equipment to a second user equipment of the sidelink communication network; and
based on the determining, providing signalling to at least one of the first user equipment or the fourth user equipment to avoid the resource conflict.

28. The method of claim 27, wherein the information comprises a sidelink positioning reference signal configuration and reservation.

29. The method of claim 27, wherein the signalling comprises one of a skip pre-emption indication or signalling to the first user equipment or a frequency offset indication to the fourth user equipment.

30. The method of claim 29, wherein the skip pre-emption indication or signalling causes the first user equipment to refrain from applying pre-emption or reselection of sidelink resources regardless of whether pre-emption is disabled or enabled in a resource pool at the first user equipment.

31. The method of claim 29, wherein the skip pre-emption indication or signalling is multiplexed with at least one of physical sidelink shared channel or physical sidelink feedback channel resources associated with an existing physical sidelink shared channel of the first user equipment.

32. The method of claim 31, wherein the skip pre-emption indication or signalling is multiplexed in a frequency domain or a code domain using a specific cyclic shift of the physical sidelink feedback channel resources.

33. The method of claim 29, wherein the frequency offset indication is signalled in a sidelink control information associated with the sidelink positioning reference signal.

34. An apparatus comprising:
at least one processor; and
at least one non-transitory memory including computer program code, where the at least one non-transitory memory and the computer program code are configured, with the at least one processor, to cause the apparatus to at least:
determine, by a third user equipment, information identifying at least one selected sidelink resource for use in sidelink operations with a fourth user equipment in a sidelink communication network;
identify a resource conflict of the at least one selected sidelink resource with at least one sidelink data transmission from a first user equipment to a second user equipment of the sidelink communication network; and
based on the determining, provide signalling to at least one of the first user equipment or the fourth user equipment to avoid the resource conflict.

35. The apparatus of claim 34, wherein the information comprises a sidelink positioning reference signal configuration and reservation.

36. The apparatus of claim 34, wherein the signalling comprises one of a skip pre-emption indication or signalling to the first user equipment or a frequency offset indication to the fourth user equipment.

37. The apparatus of claim 36, wherein the skip pre-emption indication or signalling causes the first user equipment to refrain from applying pre-emption or reselection of sidelink resources regardless of whether pre-emption is disabled or enabled in a resource pool at the first user equipment.

38. The apparatus of claim 36, wherein the skip pre-emption indication or signalling is multiplexed with at least one of physical sidelink shared channel or physical sidelink feedback channel resources associated with an existing physical sidelink shared channel of the first user equipment.

39. The apparatus of claim 38, wherein the skip pre-emption indication or signalling is multiplexed in a frequency domain or a code domain using a specific cyclic shift of the physical sidelink feedback channel resources.

40. The apparatus of claim 36, wherein the frequency offset indication is signalled in a sidelink positioning reference signal frequency offset sequence.

41. The apparatus of claim 36, wherein the frequency offset indication is indicating an offset of the more than one selected sidelink resource in order for the at least one sidelink data transmission and the more than one selected sidelink resource to occur on non-overlapping sidelink resources.

42. The apparatus of claim 36, wherein the frequency offset indication comprises at least one of:
a number of offsetted subcarriers,
a number of offsetted resource blocks, or
a number of offsetted subchannels.

43. The apparatus of claim 42,
wherein the number of offsetted subcarriers is used in case the at least one selected sidelink resource granularity is at least one sub-carrier,
wherein the number of offsetted resource blocks is used in case the at least one selected sidelink resource granularity is at least one physical resource block, and
wherein the number of offsetted subchannels is used in case the at least one selected sidelink resource granularity is at least one sub-channel.

44. The apparatus of claim 36, wherein the information comprises one of a down shift direction to a lower frequency or an up shift direction to a higher frequency of the frequency offset indication.

45. The apparatus of claim 36, wherein the frequency offset indication corresponds to a pre-defined value.

46. The apparatus of claim 34, wherein the information identifying the at least one selected sidelink resource is for localizing the third user equipment.
